(19) United States
(12) Patent Application Publication
(10) Pub. No.: US 2007/0288387 A1
(43) Pub. Date: Dec. 13, 2007

(54) Method and apparatus for effecting the return of a rights management object

(76) Inventors: Joon Young Park, Libertyville, IL (US); Hosame H. Abu-Amara, Round Lake, IL (US); James Hu, Hoffman Estates, IL (US); Douglas T. Michau, Grayslake, IL (US)

Correspondence Address: MOTOROLA INC, 600 NORTH US HIGHWAY 45, W4 - 39Q, LIBERTYVILLE, IL, 60048-5343, US

(21) Appl. No.: 11/448,492

(22) Filed: Jun. 7, 2006

(51) Int. Cl. G06Q 99/00

(52) U.S. Cl. 705/59

(57) ABSTRACT

A system and method for returning a rights management object (103) to a rights issuer (102) is provided. The system and method allows a rights issuer (102) to ensure that the rights management object (103) is removed from an electronic device (101) prior to making the refund, while providing the customer with the ability to retrieve the rights management object (103) where the return is unsuccessful. After initiating a return, an electronic device (101) transmits probabilistic data structures (226,228) to the rights issuer (102). The probabilistic data structures (226,228) having indicia therein of rights management objects disposed within the electronic device (101). The electronic device (101) encrypts the rights management object (103), delivers it to the rights issuer (102), and removes it from the electronic device (101). By querying the probabilistic data structures (226,228), which may be Bloom filters, the rights issuer (102) is able to confirm that the rights management object (103) has been deleted from the electronic device (101).

### BACKGROUND

1. Technical Field

This invention relates generally to digital rights management in electronic devices, and more specifically to a method and apparatus for assuredly returning a rights management object to a rights issuer.

2. Background Art

Electronic devices are becoming more and more commonplace in society. While once it was a novelty to see someone speaking on a mobile telephone, today many people carry multiple electronic devices everywhere they go. For instance, a student may carry a mobile telephone, laptop computer, personal digital assistant (PDA), and portable music player when going to class. Similarly, a businessperson may take a portable computer, a wireless e-mail enabled device, a mobile telephone, and a pager to and from work. Likewise, a child may take a portable music player, video player, or gaming device to the park to play.

With improvements in both the technology of these devices and the networks to which they connect, more and more devices are being designed to accommodate downloadable content. For example, in the field of music, there was a time where a person had to go to a record store to buy a record, tape, or compact disc to listen to music on a portable music player. With new MP3 players, some equipped with wireless connections to the Internet, today one simply downloads a song of choice, which is suitable for play instantly. In addition to music content, image content, video content, gaming content, software content, and other applications are now available for electronic download to electronic devices.

One tension with this easy access to content is intellectual property rights. When a person pays a music distributor for a downloaded song, the artist, publisher, and distributor would like to ensure that associated copyright protections will remain in place. While the purchaser of the song is free to enjoy the song, copyright holders need a way to prevent unauthorized copying of the protected digital media. With the advent of computers and other portable electronic devices, it is often simple to copy, modify, or redistribute protected works without authorization.

Digital rights management is a term that broadly describes the new technologies by which content providers enforce limitations on the use and distribution of content. There are many aspects to digital rights management, including authentication of content, authorization to use content, accounting for royalties and payments, rights verification, rights enforcement, and content protection.

There have been several attempts at digital rights management in electronic devices. One method is simple encryption. With simple encryption, an encrypted file is transferred to a user. The file can be downloaded, but cannot be executed or opened until a password is provided. Once the payment, conditions, and other terms of use have been satisfied, a content provider provides the user with a password. The user employs the password to open the file. The problem with encryption is that while it protects the file during delivery, it provides no mechanism to prevent unauthorized redistribution once the file is opened.

Another approach is by using a “rights management object.” In digital rights management using rights management objects, two files are transferred from content provider to user: an encrypted content file and a rights management object. The rights management object is required to use the encrypted content file. A rights management object may include an encryption key capable of decrypting or unlocking the content file. While the encrypted content file can be freely copied or redistributed, the rights management object includes usage limitations. For example, the rights management object may only permit the content file to be opened a certain number of times or on a certain number of devices.

The problem with rights management object based digital rights management occurs with transfer verification. While it is easy to verify that a transferred file has been received, the recipient has no way of determining whether copies still exist on the transferor's device. By way of example, consider digital music. A person may purchase a song for download, and may in turn receive a content file and a rights management object. The rights management object may specify that the person may listen to the song up to twenty times. However, after a single play, the person may realize that he downloaded the wrong song. Alternatively, the person may not like the song. That person would like to be able to return the song for a partial refund. However, upon return receipt of the content file and the rights management object, the content provider has no way of knowing whether a copy of the rights management object remains in the possession of the purchaser. The content provider may be reluctant to provide a refund if the person still has the ability to listen to the song.

There is thus a need for a method and apparatus to effect the return of a rights management object to a rights issuer while verifying that the digital rights have actually been removed from the returning device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary environment suitable for one embodiment of method and apparatus in accordance with the invention.

FIG. 2 illustrates one method of returning a rights management object in accordance with the invention.

FIG. 3 illustrates one embodiment of an apparatus capable of returning a rights management object in accordance with the invention.

FIG. 4 illustrates a flow chart of one embodiment of a method of returning a rights management object as viewed from the returning device's perspective in accordance with the invention.

FIG. 5 illustrates one method of attempting to return a rights management object in accordance with the invention.

FIG. 6 illustrates a flow chart of one embodiment of a method of attempting to return a rights management object, where at least one attempt at returning the rights management object is unsuccessful.

FIG. 7 illustrates a flow chart of one embodiment of a method of returning a rights management object as viewed from the rights issuer's perspective in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to returning or otherwise transferring a rights management object in accordance with the invention. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of returning or transferring rights management objects as described herein. The non-processor circuits may include, but are not limited to, a transceiver or transmitter, signal drivers, clock circuits, power source circuits, and user input devices. As such, these functions may be interpreted as steps of a method to perform the operations of returning a rights management object. Alternatively, some or all functions could be implemented by the execution of software code, by a state machine that has no stored program instructions, or by one or more application specific integrated circuits, in which each function or some combinations of certain of the functions are implemented as custom logic. Further, it is expected that one of ordinary skill, notwithstanding possibly significant effort and many design choices motivated by, for example, available time, current technology, and economic considerations, when guided by the concepts and principles disclosed herein will be readily capable of generating such software instructions, programs or circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parentheses indicate components shown in a figure other than the one in discussion. For example, talking about a device (10) while discussing figure A would refer to an element, 10, shown in figure other than figure A.

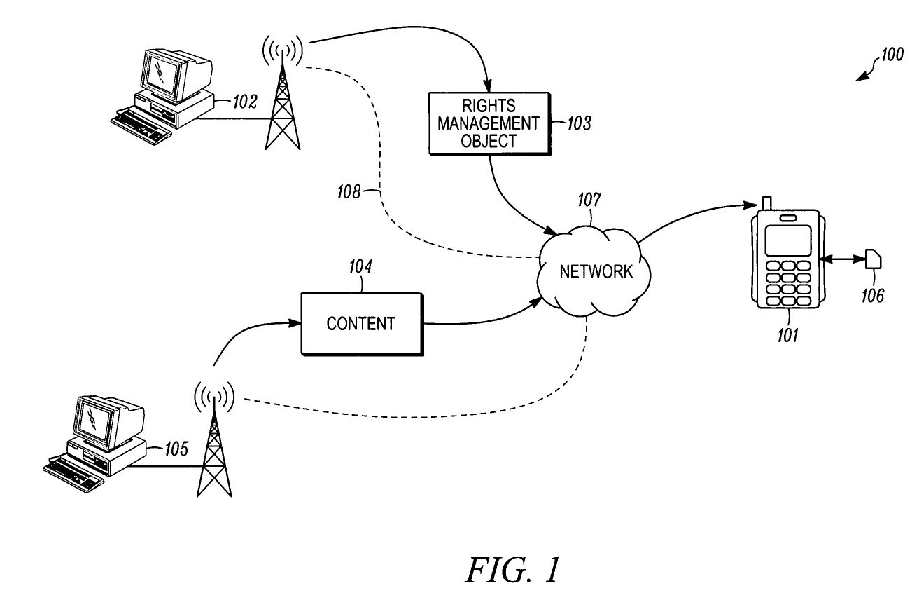

Turning now to FIG. 1, illustrated therein is one embodiment of a system 100 suitable for employing a method, apparatus, or both, for assuredly returning a rights management object 103 to a rights issuer 102. In this system, an electronic device 101, in response to requisitioning content protected by digital rights management, receives content 104 from a content provider 105 and a rights management object 103 from a rights issuer 102. The rights management object 103 permits the electronic device 101 to consume, execute, open, or otherwise operate the content 104. The content 104 may thus be described as being a rights management object governed application.

The content provider 105 and rights issuer 102 may be one in the same. For instance, the content provider 105 may be a music, video, or gaming provider with its own digital rights management infrastructure. Alternatively, the content provider 105 and the rights issuer 102 may be different entities. A music publisher, for instance, may contract with a digital rights management company for the provision of rights management systems. Where this is the case, the rights issuer 102 may communicate 108 with the content provider 105. The communication 108 may include a report of rights management object issuance details, financial accounting and so forth.

The electronic device 101 may be any device capable of receiving digital rights. These devices are generally suitable for playing, consuming, executing, opening, or otherwise operating digital content. Such devices include personal computers, laptop computers, personal digital assistants, mobile telephones, radios, pagers, music and video players, gaming devices, workstations, file servers, mainframes, or other similar devices. The electronic device 101 may include removable storage media 106, such as a SD, MMC, RS-MMC, CF, SM, or MS memory card. Alternatively, the electronic device 101 may include only an integral memory, such as flash memory or a hard drive.

The electronic device 101 is capable of communicating with the rights issuer 102 and content provider 105 either directly or via a network 107. The network 107 may include any suitable communication network through which digital communications may be conducted. Suitable networks include local area networks, wide area networks, wireless networks, wired networks, the Internet, public switched telephone networks, and proprietary communication networks. While the communications through the network 107 may be either secure or non-secure, in one embodiment secure communications are preferable as they help to prevent unwanted interception of communicated data.

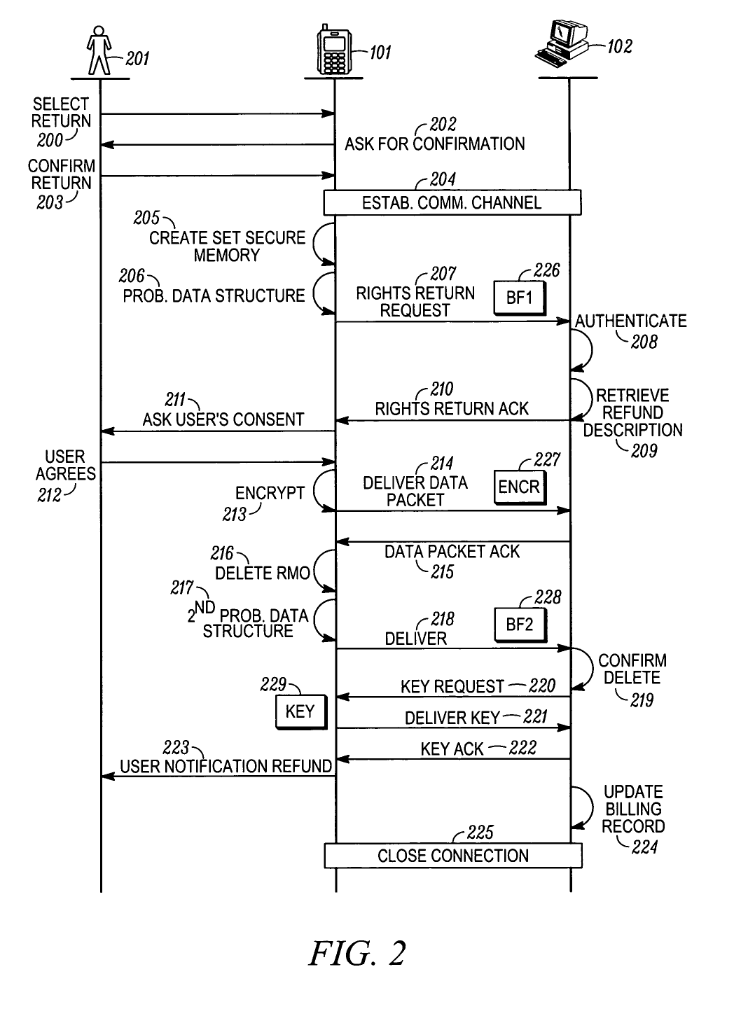

Turning now to FIG. 2, illustrated therein is an illustration of one embodiment of a method for returning a rights management object (103) in accordance with the invention. Using the musical example from above for discussion purposes, presume that a user 201 has purchased a song that is governed by a rights management object. The user 201 has downloaded the song, and the rights management object (103) permits the song to be played twenty times. Upon hearing the song the first time, the user 201 realizes that the downloaded song is by the wrong artist. Thus, the user 201 would like to return the song for a refund of 19/20ths of the purchase price.

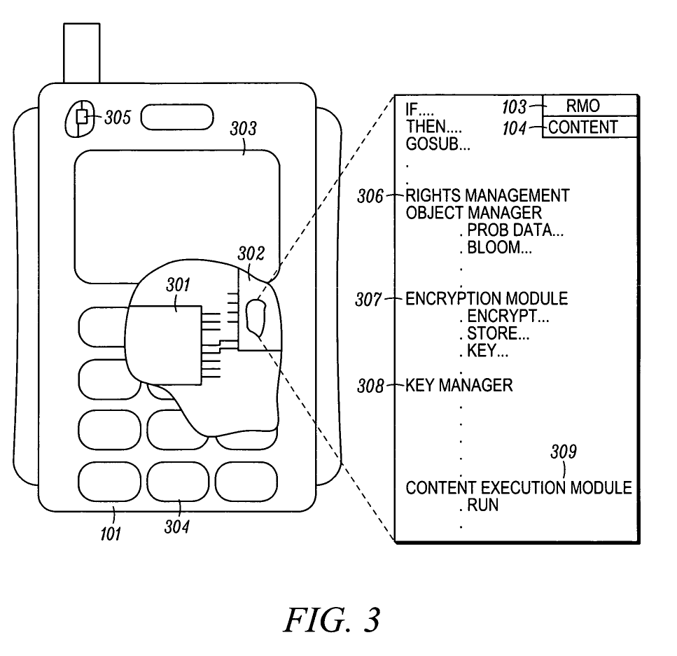

The user 201 scrolls through a list of rights management objects on his electronic device 101. This scrolling and viewing may be accomplished with a user interface and display as will be described in conjunction with FIG. 3. Upon finding the rights management object that needs to be returned, the electronic device 101 presents the user 201 with a selection of options for the rights management object, one of these options being “return”. At step 200 the user 201 selects the return operation. A confirmation dialogue displaying the amount of usage remaining for the rights management object is presented to the user 201. The electronic device 101 requests the user's confirmation at step 202. The user 201 then confirms the return request at step 203.

To execute the return operation, the electronic device 101 now establishes a secure communication connection at step 204. While an unsecured channel may be used, secured channels are often preferred to prevent an unauthorized party from intercepting the content (104) or the rights management object (103). Secure channels may also prevent an unauthorized party from eavesdropping on the communication between the electronic device 101 and the rights issuer 102. Once the secure communication connection is established, the rights issuer 102 is able to authenticate the electronic device 101.

The electronic device 101 then generates detailed information about the rights management object to be returned. This detailed information may include, but is not limited to, unique identifiers associated with the rights management object (103) or a secure hash value associated with the rights management object (103). A unique identifier is any information that will allow the rights issuer 102 to identify the rights management object (103) during return. For example, a secure hash value may be created from the combination between the binary specification of the rights management object (103) and its state. Examples of a secure hash include MD5, SHA-1, and HMAC.

One object of the invention is that the electronic device 101 is able to ensure the rights issuer 102 that the rights management object 103, upon successful return to the rights issuer 102, is no longer present on the device. This is accomplished, in accordance with the invention, by the use of probabilistic data structures.

At step 205, the electronic device 101 creates a set of all rights management objects residing within the electronic device 101 and writes this set to secure memory. At step 206, the electronic device 101 generates a probabilistic data structure 226 having indicia therein of the set of rights management objects from the secure memory. In one embodiment, this probabilistic data structure 226 is a Bloom filter constructed from the set of rights management objects in secure memory. A Bloom filter, first conceived by Burton H. Bloom in 1970, is a probabilistic data structure that can be used to test whether a particular element is a member of a set. False positives are possible, but false negatives are not. For a study of false positive rates, see http://www.cs.wisc.edu/˜cao/papers/summary-cache/node8.html, which is incorporated herein by reference. A Bloom filter can be generated using any publicly available and standardized hash functions, such as MD5 (standardized by the Internet Engineering Task Force in RFC 1321), SHA-1 (standardized by the National Institute of Standards and Technology in FIPS PUB 180-1), and HMAC (standardized by the Internet Engineering Task Force in RFC 2104). A methodology for creating Bloom filters can be found in an article published by J. Marais and K. Bharat entitled Supporting Cooperative and Personal Surfing with a Desktop Assistant, Proceedings of ACM UIST'97, October 1997 (Available on-line at ftp://ftp.digital.com/pub/DEC/SRC/publications/marais/uist97paper.pdf), which is hereby incorporated by reference.

At step 207, the electronic device 101 delivers the Bloom filter and the unique information about the rights management object (103) to the rights issuer 102. At step 208, upon receipt of the rights management object unique identifier and the Bloom filter, the rights issuer 102 authenticates that the rights management object (103) is present on the electronic device 101. At step 209, the rights issuer 102 also fetches the current state of the rights management object. In this example, the rights issuer 102 determines that one of twenty uses has been consumed. The rights issuer 102 then delivers a rights return request acknowledgement to the electronic device 101 at step 210. The rights return request acknowledgement may include a refund description.

At step 211, the electronic device 101 may present the refund description to the user 201 for approval. Where this occurs, the user 201 may agree to the terms of the refund at step 212.

Assuming that the return is approved by the user 201, the electronic device 101 at step 213 encrypts the rights management object with a secret key. In one embodiment, the electronic device 101 encrypts the rights management object using a publicly available and standardized encryption method, such as AES (standardized by the National Institute of Standards and Technology in FIPS PUB 197), 3DES (standardized by the National Institute of Standards and Technology in FIPS PUB 46-2), or RC4 (publicly available from RSA Security Laboratories). The encryption yields an encrypted packet 227 and a key 229, both of which must be obtained to unlock the encrypted contents of the packet 227.

At step 214, the electronic device 101 transmits the key-encrypted data packet 227 to the rights issuer 102 without transmitting the key 229. The rights issuer 102, upon receipt of the key-encrypted data packet 227, delivers a data packet acknowledgement at step 215.

Once the electronic device 101 receives the data packet acknowledgement confirming that the rights issuer 102 has received the key-encrypted data packet 227, the electronic device 101 erases the rights management object from internal memory. As such, the rights management object is no longer present within the electronic device 101.

At step 217, the electronic device 101 generates another probabilistic data structure 228 from the new set of rights management objects residing in the electronic device 101. This new set, presuming no rights management object downloads or other erasures, will be the same set generated in step 205 less the rights management object deleted in step 216. The electronic device 101 then delivers the second probabilistic data structure 228, which in one embodiment is a second Bloom filter, to the rights issuer 102 at step 218.

The rights issuer 102 then confirms that the rights management object has been deleted from the electronic device 101 at step 219 by comparing the second probabilistic data structure 228, transmitted at step 218, with the first probabilistic data structure 226 transmitted at step 207. Where each probabilistic data structure is a Bloom filter, and the comparison yields a negative result, the rights issuer 102 is assured that the rights management object is no longer resident within the electronic device 101. This is so because Bloom filters cannot yield false negatives.

Upon confirming that the rights management object is no longer resident in the electronic device 101, the rights issuer 102 transmits a second probabilistic data structure acknowledgement at step 220. This second probabilistic data structure acknowledgement may include a key request. Upon receiving the second probabilistic data structure acknowledgement, the electronic device 101 transmits the key 229 to the rights issuer 102 at step 221.

Upon receipt of the key 229, the rights issuer 102 may transmit a return complete message to the electronic device 101 at step 222. The electronic device 101 may present this message to the user 201 at step 223. The rights issuer 102 then updates the user's billing account at step 224. The communication channel is then closed at step 225.

Turning now to FIG. 3, illustrated therein is one embodiment of an electronic device 101 suitable for effecting the return of a rights management object, such as that illustrated in FIG. 2, in accordance with the invention. The electronic device 101 employs circuits and modules to operate the core functions of the device, as well as the functions of the present invention. The modules may include software and hardware elements. In one embodiment, several of the modules comprise executable software code residing in memory 302. Thus, a module may include, by way of example, components, such as software components, object-oriented software components, subroutines, firmware, data, data structures, tables, arrays, and variables. The modules may be implemented such that they execute in one or more processors, e.g. controller 301, within the electronic device 101.

The electronic device 101, shown illustratively as a mobile radiotelephone, includes a display 303 and a user interface 304. The display 303, which may be a liquid crystal display, presents data and information to the user (201). The user interface 304, shown here as a keypad, allows the user (201) to enter information or call programs and applications. While a mobile radiotelephone is used as an illustrative embodiment, it will be clear to those of ordinary skill in the art having the benefit of this disclosure that the invention is not so limited. Other electronic devices may use circuits and modules in accordance with the invention.

A controller 301 controls the operation of the electronic device 101. The controller 301 is coupled to a memory 302, within which various software codes and instructions may be stored. In addition to storing software instructions, the memory 302 may also used to store content 104, such as audio, video, or gaming content, and at least one rights management object 103. Where a rights management object 103 is required to open, execute, or run the content 104 stored in memory 302, the content 104 may be referred to as a rights management object governed application, and is executable by a content execution module 309. The controller 301 is capable of processing the rights management object governed application, i.e. content 104, when the rights management object 103 is resident within the memory 302.

A transceiver 305, which may be a wireless transceiver, is coupled to the controller 301 and facilitates transmission and receipt of packet data between the electronic device 101 and a remote host, such as a rights issuer (102). The packet data may include the rights management object 103, but may also include electronic content, including rights management object governed applications.

A rights management object manager 306, shown illustratively in FIG. 3 as software code resident in the memory 302, is operable with the controller 301. The rights management object manager 306 is configured to generate probabilistic data structures, such as the Bloom filters discussed in FIG. 2. The probabilistic data structures include indicia of rights management objects disposed within the electronic device 101. Thus, in one embodiment, the probabilistic data structures comprise Bloom filters having indicia therein of a plurality of rights management objects disposed within the memory 302.

Upon delivery of the first probabilistic data structure to the rights issuer (102), the rights management object manager 306 is configured to remove the rights management object being returned from memory 302. Per the illustrative steps of FIG. 2, this removal from memory 302 occurs between the generation of the first probabilistic data structure and the second probabilistic data structure.

An encryption module 307 is operable with the controller 301. The encryption module 307 is configured to generate the key-encrypted data packets and associated keys. Using the illustration of FIG. 2, in one embodiment, the encryption module 307 is configured to generate at least one key-encrypted data packet containing the rights management object to be returned, as well as the key associated with that data packet.

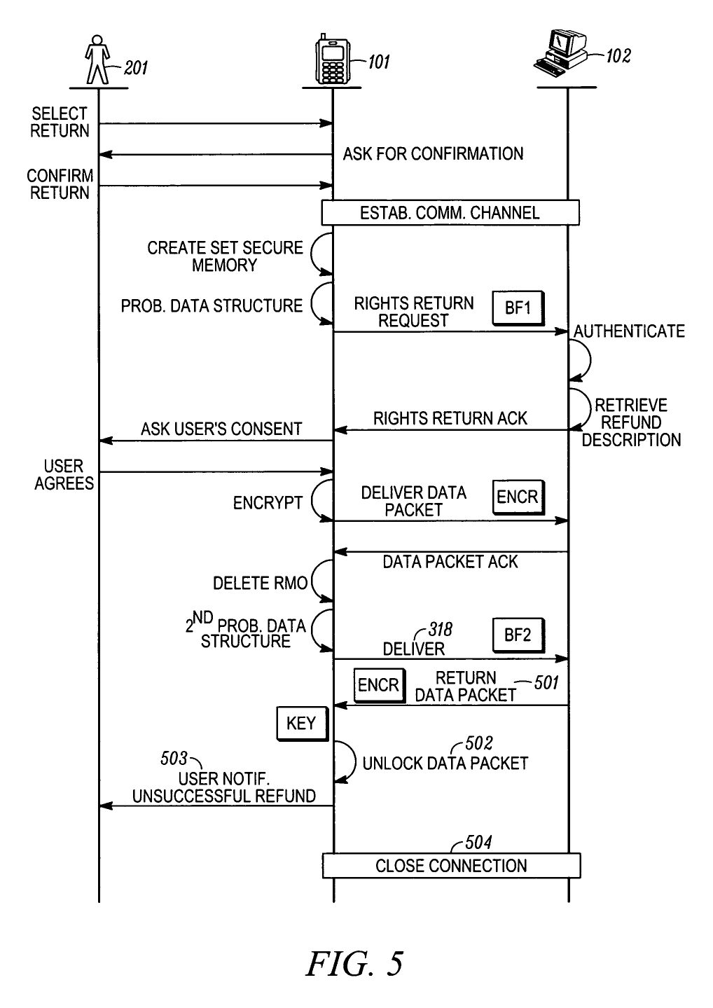

A key manager 308, operable with the controller 301, is configured to deliver the key to a remote host, such as a rights issuer (102). In accordance with the steps of FIG. 2, in one embodiment, the key manager 308 only delivers the key after the transceiver 305 has delivered both the first probabilistic data structure and the second probabilistic data structure to the rights issuer (102), and only then upon receiving the key request from the rights issuer (102). Some reasons for retaining the key until these steps have occurred will be discussed below with reference to FIG. 5.

Where something goes awry, for example where the secure communication channel between the electronic device (101) and the rights issuer (102) is broken prior to completing the delivery request, the electronic device (101) must have the key-encrypted data packet returned. Thus, in one embodiment, the key manager 308 is configured such that in the absence of receipt of the key request, or perhaps the absence of receipt of the key request within a predetermined time period, the key manager 308 will cause the transceiver 305 to deliver a data packet retrieval request. This delivery of the data packet retrieval request ensures that the user (201) does not pay for content, only to find that the content is unusable due to a technical glitch in the return process.

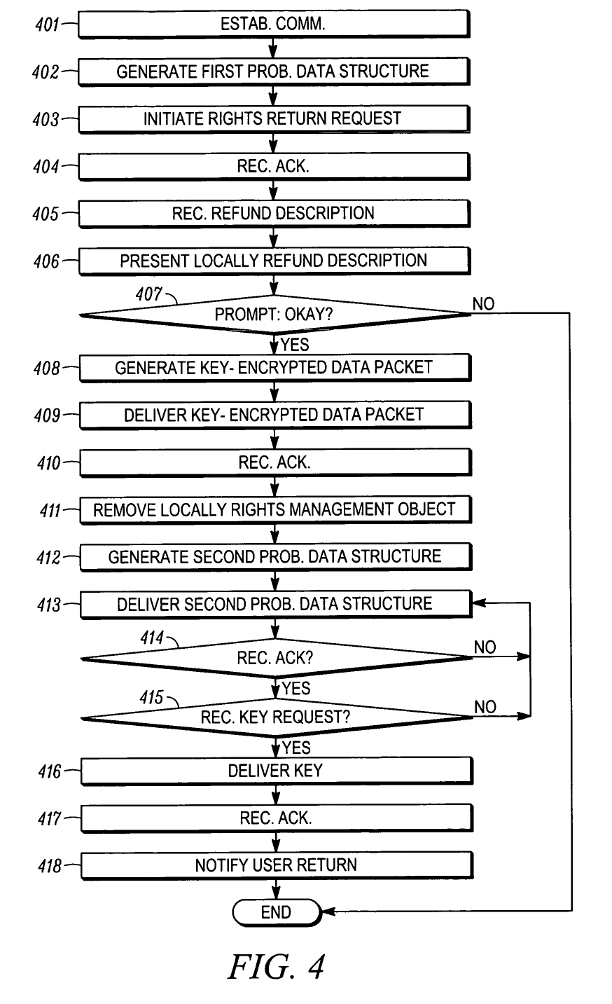

Turning now to FIG. 4, illustrated therein is a flow chart showing one embodiment of a rights management object return process in accordance with the invention as seen from the electronic device's perspective. This flowchart may be embodied as executable software stored within the memory (302) of the electronic device (101).

At step 401, the electronic device (101) establishes a communication channel between the electronic device (101) and the rights issuer (102). At step 402, the electronic device (101) creates a first probabilistic data structure having indicia therein of a first plurality of rights management objects disposed within the local electronic device (101). By way of example, this first probabilistic data structure may be a Bloom filter including the set of all rights management objects in the electronic device (101), including the rights management object to be returned.

At step 403, the electronic device (101) initiates a rights return request that includes the first probabilistic data structure. This rights return request may include sending a preliminary message indicating that a return process is about to occur. The rights return request also includes delivering the first probabilistic data structure to the rights issuer (102).

At step 404, the electronic device (101) may receive a rights return request acknowledgement from the rights issuer (102). This acknowledgement is in response to the initiation of the rights return request. The electronic device (101) may also receive a refund description at step 405, which is then presented locally to the user (201) at step 406. As the rights management objects in some applications may be expiratory, the refund description may include a percentage or other partial description of the purchase price. At decision 407, the electronic device (101) may prompt the user (201) as to whether to proceed with returning the rights object management. For example, the electronic device (101) may ask the user (201) whether the refund description is acceptable.

Where the refund request is acceptable, the electronic device (101) generates a key-encrypted data packet and the corresponding key at step 408. In one embodiment, the key-encrypted data packet is a temporal key integrity protocol data packet with an RC4 traffic key associated therewith. The electronic device (101) then delivers the key-encrypted data packet having the rights management object to be returned therein, without delivering the key, at step 409. At step 410, the electronic device (101) receives a data packet acknowledgement in response to delivering the packet.

At step 411, the electronic device (101) removes from local memory the rights management object to be returned. The electronic device (101) then creates a second probabilistic data structure at step 412. The second probabilistic data structure, which may also be a Bloom filter, has indicia therein of a second plurality of rights management objects disposed within the electronic device (101). Since the rights management object to be returned has been erased, the second plurality of rights objects fails to include the rights management object to be returned. At step 413, the second probabilistic data structure is delivered to the rights issuer (102).

At decision 414, the electronic device (101) determines whether a second probabilistic data structure acknowledgement has been received from the rights issuer (102). Where it has, upon receipt of the second probabilistic data structure acknowledgement, the electronic device (101) determines at decision 415 whether the key request has been received from the rights issuer (102). Where it has, the electronic device (101), or the key manager (308) within the electronic device (101), delivers the key to the rights issuer (102) at step 416. Where the electronic device (101) receives a key delivery or return complete acknowledgement at step 417, the electronic device (101) may present a message locally to the user (201) that the rights management object has been returned by way of the display (303).

Where the probabilistic data structure used is a Bloom filter, the rights issuer (102) is assured that the rights management object has been removed from the electronic device (101) whenever a comparison of the first Bloom filter and the second Bloom filter yields a negative result. However, as has been alluded to above, problems can arise during the return process. For example, where the electronic device (101) is battery powered, the battery may run out of energy during the return process, prior to completion of the return process. Additionally, the communication channel may be interrupted prior to the completion of the return process. Next, while the probability is small, comparison of the first and second Bloom filters may yield a positive even where the electronic device (101) fully erased the rights management object being returned. Generally speaking, where the comparison yields a positive, there is a high probability that the electronic device (101) did not erase the rights management object. However, as false positives can occur with Bloom filters, there is no way for a rights issuer (102) to determine whether the rights management object has been deleted. As such, and to accommodate other technological issues that may arise, the electronic device (101) must have a mechanism to restore the encrypted rights management object to local memory. Such a process is set forth in FIG. 5.

Turning now to FIG. 5, the steps are essentially the same as shown in FIG. 3 until the delivery of the second probabilistic data structure at step 318. The illustration of FIG. 5 is exemplary of the situation where the rights issuer 102 obtains a positive result from comparing the probabilistic data structures. However, the process of rights management recovery set forth therein may be used in any case where the return process is not completed, regardless of reason.

In FIG. 5, the rights issuer 102 delivers an acknowledgement of a positive filter comparison result. As such, the rights issuer 102 delivers the key-encrypted data packet back to the electronic device 101 at step 501. As the electronic device 101 has retained the key, the electronic device 101 may unlock the rights management object at step 502. The electronic device 101 may notify the user 201 that the return was unsuccessful at step 503. The electronic device 101 may then close the communication channel at step 504. Thus, when the return process is unsuccessful, the electronic device 101 requests a return of the key-encrypted rights management object.

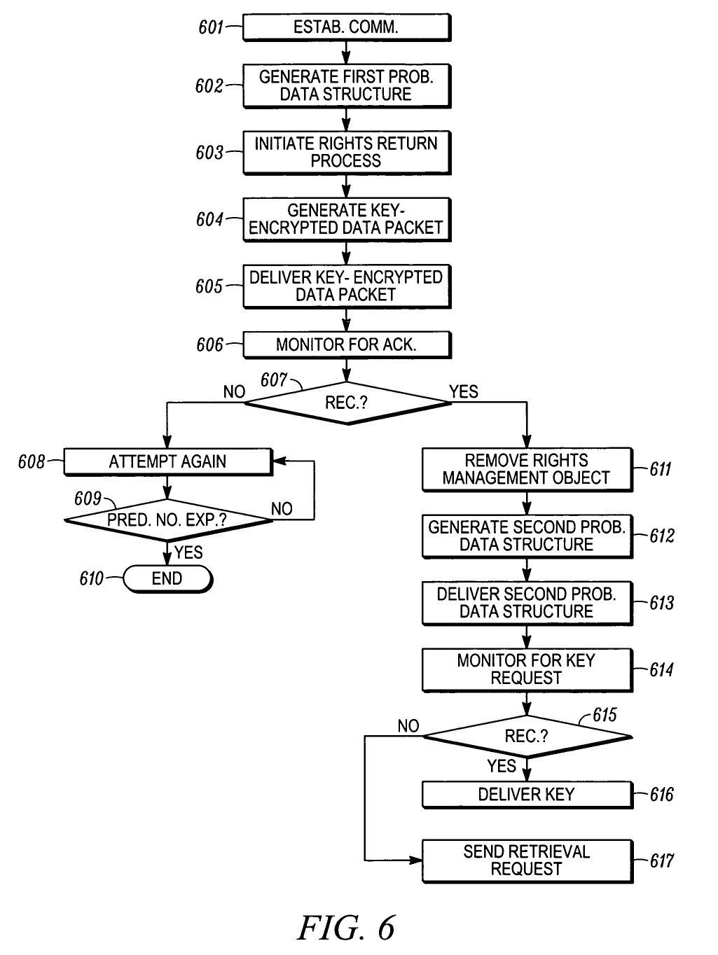

Turning now to FIG. 6 illustrated therein is a flowchart of a method for returning a rights management object when at least one attempt to return the rights management object has been unsuccessful. While FIG. 5 illustrated a single return attempt, the method of FIG. 6 illustrates one embodiment where multiple return attempts are executed prior to notifying the user (201) that the return was unsuccessful.

At step 601, the electronic device (101) establishes a communication channel between itself and the rights issuer (102). At step 602, the electronic device (101) creates a first probabilistic data structure having indicia therein of a first plurality of rights management objects disposed within the local electronic device (101). At step 603, the electronic device (101) initiates the rights return request by transmitting the first probabilistic data structure to the rights issuer (102).

After encrypting the rights management object with key-based encryption at step 604, the electronic device (101) delivers the key-encrypted data packet comprising the rights management object to the rights issuer (102) at step 605. The electronic device (101) does this without delivering the key.

The electronic device (101) then monitors for a data packet acknowledgement from the rights issuer (102) in response to delivering the key-encrypted data packet at step 606. At decision 607, the electronic device (101) determines whether the data packet acknowledgement has been received.

Where it has not, the electronic device (101) initiates the rights return request again at step 608. This initiation may include delivering the key-encrypted data packet again and again monitoring for a data packet acknowledgement. This additional initiation may occur for at least a predetermined number of attempts, as is indicated by decision 609. Where the predetermined number of attempts has expired, and no data packet acknowledgement has been received, the electronic device (101) may abort the rights management object return process at step 610.

Where the electronic device (101) determines that the data packet acknowledgement is received at decision 607, the electronic device (101) removes the rights management object from local memory at step 611. The electronic device (101) then creates the second probabilistic data structure at step 612 and delivers the second probabilistic data structure to the rights issuer (102) at step 613.

The electronic device (101) then monitors for the key request from the rights issuer (102) at step 614. The electronic device (101) determines whether the key request is received at decision 615. Where the key request is received, upon receipt the electronic device (101) delivers the key to the rights issuer (102) at step 616. Where the electronic device (101) fails to receive the key request, the electronic device (101) transmits a data packet retrieval request to the rights issuer at step 617.

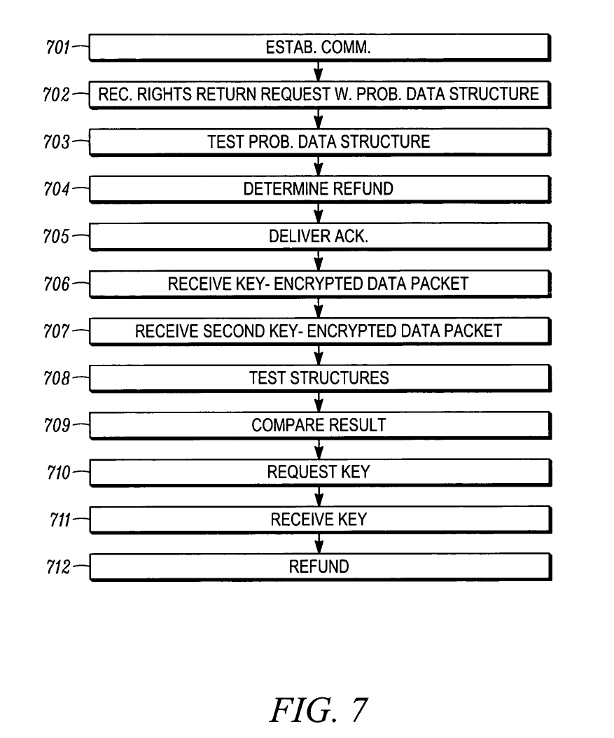

Turning now to FIG. 7, illustrated therein is one embodiment of a method for refunding a rights management object purchaser for returning the rights management object as seen from the rights issuer's perspective. At step 701, the communication channel with the client is established. This channel may be established by a customer interested in making a return. The client is any device capable of effecting a transfer of a rights management object (103) in accordance with the invention, including computers, portable electronic devices, or multimedia devices.

At step 702, the rights issuer (102) receives a return request from the client. In one embodiment, the rights return request includes a first probabilistic data structure having indicia of a first plurality of rights management objects included therein. The plurality of rights management objects include all rights management objects disposed within the client. This set includes indicia of the rights management object to be returned.

At step 703, the rights issuer (102) may query the first probabilistic data structure to determine, for example, that it is proper form and includes the rights management object to be returned. At step 704, the rights issuer (102) reviews the customer's account to determine the terms and conditions of the refund. For instance, in one embodiment the rights management object is expiratory in nature. In other words, the rights management object may be of limited duration or may include a limited number of uses. Where this is the case, the rights issuer (102) determines what amount to refund the customer (301) at step 704. At step 705, the rights issuer (102) delivers a rights return request acknowledgement to the client in response to receiving the rights return request. This rights return request acknowledgement may include a refund description having indicia of a portion of a rights management object purchase price to be refunded.

At step 706, the rights issuer (102) receives a key-encrypted data packet that includes the rights management object. The key-encrypted data packet is delivered at step 706 without the key.

At step 707, the rights issuer (102) receives a second probabilistic data structure from the client. This second probabilistic data structure may be tested for integrity at step 708. The second probabilistic data structure includes indicia of a second plurality of rights management objects disposed within the client. As the client should have removed the rights management object, the second probabilistic data structure should include all rights management objects from the first probabilistic data structure except the rights management object to be returned. The rights issuer (102) confirms this at step 709 by comparing the first probabilistic data structure and the second probabilistic data structure to determine whether one of the first probabilistic data structure and the second probabilistic data structure fails to include indicia of the rights management object to be returned. Said differently, the rights issuer (102) determines that the first Bloom filter and second Bloom filter are different.

Where this is the case, the rights issuer (102) requests the key from the client at step 710. Where the first probabilistic data structure and second probabilistic data structure comprise Bloom filters, the rights issuer requests the key when the comparison of the first Bloom filter and the second Bloom filter yields a negative result.

At step 711, the rights issuer (102) receives the key from the client. Now that the key-encrypted data packet can be unlocked, the rights issuer refunds the account of the customer, i.e. the rights management object purchaser, at step 712.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method for returning a rights management object, the method comprising the steps of:
a. establishing a communication channel between a local electronic device and a rights issuer;
b. creating a first probabilistic data structure having indicia therein of first plurality of rights management objects disposed within the local electronic device;
c. initiating a rights return request comprising the first probabilistic data structure;
d. delivering a key-encrypted data packet comprising the rights management object to be returned without delivering a key;
e. removing locally the rights management object to be returned;
f. creating a second probabilistic data structure having indicia therein of a second plurality of rights management objects disposed within the local electronic device;
g. delivering the second probabilistic data structure to the rights issuer; and
h. upon receipt of a second probabilistic data structure acknowledgement, delivering the key to the rights issuer.

2. The method of claim 1, wherein the first probabilistic data structure comprises a first Bloom filter having indicia therein of the rights management object to be returned.

3. The method of claim 2, wherein the second probabilistic data structure comprises a second Bloom filter, wherein the second plurality of rights management objects fails to include the rights management object to be returned.

4. The method of claim 1, wherein the key-encrypted data packet comprises a temporal key integrity protocol data packet, further wherein the key comprises an RC4 traffic key.

5. The method of claim 1, further comprising the steps of:
a. receiving a rights return request acknowledgement from the rights issuer in response to initiating the rights return request;
b. receiving a data packet acknowledgement in response to delivering the key-encrypted data packet; and
c. receiving a key request from the rights issuer in response to delivering the second probabilistic data structure.

6. The method of claim 1, wherein the rights management object to be returned is expiratory, further comprising the steps of receiving a rights return request acknowledgement from the rights issuer in response to initiating the rights return request, wherein the rights return request acknowledgement comprises a refund description.

7. The method of claim 6, further comprising the steps of:
a. presenting locally the refund description; and
b. prompting locally whether to proceed with returning the rights management object to be returned.

8. The method of claim 1, further comprising the step of providing notification locally that the rights management object to be returned has been returned.

9. A method for initiating a rights management object return process, the method comprising the steps of:
a. establishing a communication channel between a local electronic device and a rights issuer;
b. creating a first probabilistic data structure having indicia therein of first plurality of rights management objects disposed within the local electronic device;
c. initiating a rights return request comprising the first probabilistic data structure;
d. delivering a key-encrypted data packet comprising the rights management object without delivering a key;
e. monitoring for a data packet acknowledgement from the rights issuer in response to delivering the key-encrypted data packet;
f. where the data packet acknowledgement is not received, for at least a predetermined number of attempts, initiating again the rights return request, delivering again the key-encrypted data packet, and monitoring again for the data packet acknowledgement; and
g. upon the at least a predetermined number of attempts expiring, aborting the rights management object return process.

10. The method of claim 9, wherein upon receiving the data packet acknowledgement, the method further comprising the steps of:
a. removing locally the rights management object;
b. delivering a second probabilistic data structure to the rights issuer; and
c. upon receipt of a key request, delivering the key to the rights issuer.

11. The method of claim 9, wherein upon failing to receive the key request, the method further comprising the step of transmitting a data packet retrieval request.

12. A method of refunding a rights management object purchaser for returning a rights management object, the method comprising the steps of:
a. upon establishment of a communication channel with a client, receiving a rights return request comprising a first probabilistic data structure having indicia of a first plurality of rights management objects disposed within the client;
b. delivering a rights return request acknowledgement to the client in response to receiving the rights return request;
c. receiving a key-encrypted data packet comprising the rights management object, wherein the key-encrypted data packet is without a key;
d. receiving a second probabilistic data structure having indicia of a second plurality of rights management objects disposed within the client;
e. comparing the first probabilistic data structure and the second probabilistic data structure to determine whether one of the first probabilistic data structure and the second probabilistic data structure fails to include indicia of the rights management object; and
f. requesting the key from the client.

13. The method of claim 12, further comprising the steps of:
a. receiving the key; and
b. refunding an account of the rights management object purchaser.

14. The method of claim 12, wherein the rights management object is expiratory, further wherein the rights return request acknowledgement comprises a refund description, wherein the refund description comprises indicia of a portion of a rights management object purchase price to be refunded.

15. The method of claim 12, wherein both the first probabilistic data structure and the second probabilistic data structure comprise Bloom filters.

16. The method of claim 15, wherein the first probabilistic data structure and the second probabilistic data structure are different.

17. An electronic device compatible with rights management objects governed applications, the electronic device comprising:
a. a memory for storing at least one rights management object governed application and at least one rights management object;
b. a controller coupled to the memory, the controller being capable of processing the at least one rights management object governed application;
c. a transceiver coupled to the controller, the transceiver being capable of communication between the electronic device and a remote host;
d. a rights management object manager operable with the controller, the rights management object manager being configured to generate probabilistic data structures comprising indicia of rights management objects disposed within the electronic device;
e. an encryption module operable with the controller, the encryption module being configured to generate at least a key encrypted data packet comprising the at least one rights management object and a key; and
f. a key manager, wherein upon the transceiver delivering a first probabilistic data structure, the key encrypted data packet, and a second probabilistic data structure to the remote host, and upon receiving a key request, the key manager causes the transceiver to deliver the key to the remote host.

18. The electronic device of claim 17, wherein the rights management object manager is configured to remove the at least one rights management object from the memory between generation of the first probabilistic data structure and generation of the second probabilistic data structure.

19. The electronic device of claim 17, wherein the key manager is configured such that in absence of receipt of the key request, the key manager causes the transceiver to deliver a data packet retrieval request.

20. The electronic device of claim 17, wherein the electronic device comprises a radiotelephone, further wherein one of the first probabilistic data structure and the second probabilistic data structure comprises a Bloom filter having indicia therein of a plurality of rights management objects disposed within the memory.
